(19) United States
(12) Patent Application Publication
(10) Pub. No.: US 2013/0059690 A1
(43) Pub. Date: Mar. 7, 2013

(54) High Performance Toothed Belt

(71) Applicants: Danilo Di Cesare, Pescara (IT); Ernesto Galan Sanchez, L'Arboc Del Penedes-Tarragona (ES)

(72) Inventors: Danilo Di Cesare, Pescara (IT); Ernesto Galan Sanchez, L'Arboc Del Penedes-Tarragona (ES)

(73) Assignee: Megadyne S.p.A., Mathi (IT)

(21) Appl. No.: 13/309,185

(22) Filed: Dec. 1, 2011

(30) Foreign Application Priority Data
Sep. 7, 2011 (IT) TO2011A000797

(51) Int. Cl. F16G 1/21

(52) U.S. Cl. 474/205

(57) ABSTRACT

A toothed belt is described, comprising resistant inserts that each have a total diameter, indicated by φtot, in the range between 0.9 and 3 mm. The resistant insert consist of a core consisting of at least one yarn of fibres of a first material having a diameter φc and a number N of cover yarns of fibres of a second material. The number of cover yarns N is in the range between 10 and 25 and the N yarns entirely surround the core, moreover the ratios between the total diameter of the resistant insert and the core diameter are in the range 0.4<K<1, where K=φtot/2−(φtot−φc)/4.

The present invention relates to a high performance toothed belt.

### BACKGROUND OF THE INVENTION

Toothed belts generally comprise a body of elastomeric material having teeth on at least one of the working surfaces, a cover fabric adhering to the surface of the same teeth and resistant inserts, hereinafter also referred to as “cords”, within the body.

Each component of the belt contributes to increasing the performance in terms of mechanical resistance, so as to decrease the risk of belt breaking and increase the specific transmissible power.

The cover fabric of toothed belts protects the working surface of the belt from wear due to the friction between the sides of the belt teeth and the sides of the pulley cavities the belt interacts and meshes with. Moreover, the cover fabric prevents any substances present in the environment where the toothed belt works from damaging it and reduces the tooth deformability and the friction coefficient on the working surface, i.e. the contact area between belt and pulley in the meshing step.

It is known to use a cover fabric consisting of a single layer, for example having a weight in the range between 100 and 500 g/m2 of the fabric surface for ensuring the necessary abrasion resistance, keeping a suitable flexibility of the belt in the winding thereof onto the pulley. Alternatively, it is also known to use a cover consisting of a dual fabric layer to improve the resistance features and increase the operating life of the toothed belts.

The resistant inserts of high performance belts in terms of transmissible power, i.e. for belts having specific transmissible powers higher than 25 kW by cm of width, are currently made with steel or aramid fibre cords, for example those available on the market with the trade names Kevlar® or Twaron®.

As it has long been known, however, aramid fibres have the drawback of having a very low time-course dimensional stability, therefore during storage a belt with resistant inserts of aramid fibres undergoes a shortening of the free development thereof, with consequent alteration (reduction) of the initial pitch; thus, during use it is subject to higher load and stresses, which normally cause an early deterioration triggered by the meshing error that generates between belt and pulley. Moreover, resistant inserts of aramid fibres require a particularly complex and expensive bonding treatment for improving the time-course dimensional stability of the same resistant insert and moreover, if not carefully carried out, this also causes problems during the belt cutting step.

On the other hand, steel resistant inserts have a very high time-course dimensional stability but have a high specific weight and moreover, since the reinforcing element is deposited helical-wise, during the belt cutting such resistant elements partially protrude from the lateral edges of the belt, with the risk of causing injuries to the operators during the assembly step of the same belt.

In order to prevent such risk it is therefore necessary to proceed with a further finishing step, which provides for the removal of the strands of the resistant inserts that protrude due to the cut and for the manual sealing of all the belt edges by adhesive in the zones where the inserts are partially protruding. Such a further finishing step implies considerable additional costs since it is manually carried out and must be carried out on every single belt.

The resistant inserts generally used in toothed belts are preferably twisted. The twisting increases the flexibility features of the same resistant insert and thus the resistant insert better withstands repeated bending cycles onto the drive pulleys. In particular, the flexibility is further improved if the final twist is of the Lang type, i.e. with both the twists required to make the resistant insert into the same direction.

However, very flexible inserts are not very stable while the resistant inserts must be able to ensure both stability and flexibility in order to make toothed belts able to cover a wide range of possible applications.

The technical solutions actually developed to date have privileged the overall stiffness increase especially for ensuring a high time-course dimensional stability and thus the steadiness of the belt pitch over time and the correct meshing with the pulleys involved in the drive. Such an example of latest generation toothed belts are those using carbon rather than glass resistant belts.

While resistant inserts made of carbon fibres are more flexible than steel ones and while they are twisted, however they do not allow a suitable flexibility.

In order to make toothed belts able to cover a wide range of possible applications and working conditions, it is necessary to have the two features available to the same extent and to the maximum possible levels. In fact, very slow drives are usually characterised by high and quite steady loads (tensile stresses) which therefore favour solutions with a high structural stiffness, high module and low deformation; conversely, drives with medium/high linear speeds generally require lower tensile loads but have high bending stresses of the structures, due to the high frequency (periodicity) of the belt passages on the mechanical members complementary to the same drive, i.e. on pulleys and tensioners.

### SUMMARY OF THE INVENTION

The object of the present invention therefore is to provide a driving belt free from the drawbacks described above, and in particular provided with a high mechanical resistance and a high specific transmissible power also in the presence of high stresses of the structures due to repeated bending.

According to the present invention, a driving belt is therefore made according to claim 1.

### BRIEF DESCRIPTION OF THE DRAWINGS

For better understanding of the present invention, it is further described also with reference to the figures, which show:

FIG. 1 is a perspective and partial view of a toothed belt according to the present invention;

FIG. 2 is a table showing the composition of different resistant inserts according to the present invention;

FIG. 3 is a table showing values of a time-course decay test over time and of some parameters of resistant inserts according to the present invention and for comparison;

FIG. 4 is a graph of time-course decay of resistant inserts according to the present invention and for comparison;

FIG. 5 is a graph of elongation to break of resistant inserts according to the present invention and for comparison; and

FIG. 6 is a graph of a time-course “survival probability” test which compares a toothed belt according to the prior art and two toothed belts according to the invention.

### DETAILED DESCRIPTION OF THE INVENTION

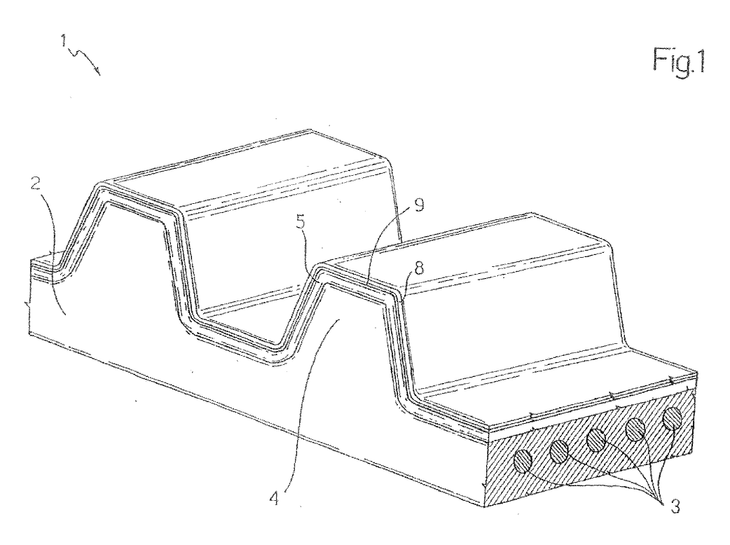

In FIG. 1, a drive toothed belt is globally indicated with reference numeral 1. Belt 1 comprises a body 2 of elastomeric material, wherein a plurality of longitudinal thread-like resistant inserts 3, hereinafter also referred to as cords, is embedded.

Body 2 has at least one toothing 4 covered by a cover fabric 5, having weft yarns 6 extending in the longitudinal direction of belt 1 and warp yarns 7 oriented in the crosswise direction of belt 1.

Body 2 comprises an elastomeric material blend having a hardness after vulcanisation in the range between 90 and 97 ShoreA, measured according to the standard procedure provided by the ASTM 2240 standard, with measurement time of 1 second, obtained without resorting to the addition of reinforcing fibres.

The elastomeric material blend comprises a main elastomer preferably selected from the group consisting of acrylonitrile/butadiene, acrylonitrile/hydrogenated butadiene, chlorosulfonated polyethylene, EPDM, chloroprene.

By main elastomer it is meant the elastomer that makes up more than 50% by weight of the belt body.

More preferably, in order to obtain optimal hardness values combined with a high wear resistance, the body is made of a blend based on one or more nitrile rubbers, where nitrile rubbers are for example: acrylonitrile/butadiene (NBR), acrylonitrile/hydrogenated butadiene (HNBR), acrylonitrile/hydrogenated butadiene and carboxylate (XHNBR), acrylonitrile/carboxylated butadiene or various mixtures of these components.

In particular, in addition to the main elastomer, the elastomeric material blend may include conventional additives, for example reinforcing agents, charges, pigments, stearic acid, accelerators, vulcanisation agents, antioxidants, activators, initiators, plasticisers, waxes, pre-vulcanisation inhibitors and the like. For example, a white or carbon black charge may be used as a charge, which is generally added in amounts in the range between 5 and 100 phr, preferably about 70 phr. Talc, calcium carbonate, silica and the like may also be added in an amount generally in the range between 5 and 150 phr or charge-containing oil dispersions. Organosilanes may be used in amounts in the range between 0.1 and 20 phr. Sulphur-donor vulcanisation agents may be used, for example polymeric amino disulphides and polysulphides or free sulphur, but peroxide-based vulcanisation agents are preferably used, in particular with HNBR blends. The added amount varies according to the type of rubber and to the type of vulcanisation agent used, and is generally in the range between 0.1 and 10 phr. Among the most used anti-degradation agents in the blend composition are microcrystalline waxes, paraffin waxes, monophenols, bisphenols, tiophenols, polyphenols, hydroquinone derivatives, phosphites, phosphate mixtures, thioesters, naphthylamines, diphenolamines, substituted and non-substituted diarylamine derivatives, diarylphenylendiamines, paraphenylendiamines, quinolines and amine mixtures. Anti-degradation agents are generally used in an amount in the range between 0.1 and 10 phr. Representative of process oils that may be used are dithiobisbenzanilide, polyparadinitrosobenzene, xylylmercaptanes, polyethylene glycol, petroleum oils, vulcanised vegetal oils, phenolic resins, synthetic oils, petroleum resins, polymeric esters. Process oils may be used in a conventional amount between 0 and 70 phr. Among the initiators, stearic acid is generally used in an amount in the range between 1 and 4 phr. Conventional additives may further be added, such as calcium oxide, zinc oxide and magnesium oxide, generally in an amount in the range between 0.1 and 15 phr. Conventional accelerators or combinations of accelerators are also used, such as for example amines, disulphides, guanidine, thiourea, thiazoles, thiols, sulphenamides, dithiocarbamates and xanthates generally in an amount in the range between 0.1 and 15 phr. Reinforcing compounds may also be added in an amount preferably in the range between 10 and 20 phr.

Particularly preferred is a blend wherein for each 100 phr nitrile rubber there are 50 to 70 phr charge, for example carbon black, 2 to 4 phr antioxidants, 8 to 10 phr accelerator and activators, 1 to 5 phr process additives and 1 to 4 phr binding agents.

The cover fabric 5 of the toothed belt 1 may consist of one or more layers and has an overall weight, formed by the weight of the sum of layers making up the raw fabric plus that of the treatments it has been subject to, in the range between 700 and 1250 g/m2 surface. The overall weight is even more preferably in the range between 700 and 1100 g/m2 when consisting of a single layer, and between 850 and 1250 g/m2 when consisting of a double layer.

If it consists of a single layer, it may be obtained for example by the weaving technique known as 2×2 twill and has an overall thickness in the range between 2.30 and 2.80 mm and consists of a weft comprising first yarns and second yarns twisted to each other. The first yarns for example have a titre of 4×110 and for example consist of a number of 4×34 primary filaments and the second yarns for example have as titre of 6×78 and consist of a number of 6×34 primary filaments.

The first and the second yarns consist of a polymeric material, preferably aliphatic or aromatic polyamide, even more preferably of polyamide 6/6 and in detail, the first yarns of medium tenacity polyamide 6/6 and the second yarns of high tenacity polyamide 6/6, for a higher wear resistance.

Moreover, fabric 5 may also consist of two layers and in this case it preferably has an overall thickness ranging between 1.8 and 2.3 mm. The two coupled fabric layers are each made, for both the weft and the warp, with yarns consisting of a polymeric material, preferably aliphatic or aromatic, even more preferably polyamide 6/6 and in particular, high tenacity.

The cover fabric 5 is anyway selected so as to have a breaking load in the non-elastic direction (in the warp) ranging between 3000 and 5500 N on 25 mm width and an elongation to break in the elastic direction (in the weft) ranging between 130 and 180%.

The cover fabric 5 is generally treated with an adhesive, in particular RFL (by RFL it is meant resorcinol and formaldehyde latex) in an amount preferably ranging between 25 and 35% by weight for improving the adhesion of the same fabric 5 to body 2 and the abrasion resistance of belt 1 as a whole.

After the treatment with RFL the fabrics are subjected, in a conventional manner, to subsequent coating steps with blends preferably of the same type described above for the belt body, thus preferably elastomeric latexes, for example nitrile rubber-based. Fabric 5 acquires a high antistaticity degree sufficient and required for falling within the requirements provided by the reference standard for toothed belts ISO9563 of 2011, a 50% module, i.e. the tensile strength required for elongating the original dimensions of the fabric specimen by 50%, ranging between 70 and 200 N.

The resistant inserts 3 or cords according to the present invention are of the so-called “hybrid” type, i.e. they are made with at least one yarn of fibres of a first material and one yarn of fibres of a second material.

In fact, it has surprisingly been discovered that using resistant inserts 3 consisting of two different materials and with suitably selected relative diameters, it is possible to solve the above described drawbacks of known belts.

Moreover, the use of resistant inserts 3 according to the present invention allows a better adhesion of the same resistant insert 3 to the blend making up the body of belt 1 and allows a lower decay of the breaking load in fatigue tests.

Both the first and the second material used for making the resistant inserts 3 according to the present invention are preferably selected from the group consisting of glass fibres, aramid fibres, polyester fibres, carbon fibres, PBO fibres.

The first material preferably has a higher module than the second material and more cover fibre yarns than the second material are wound so as to entirely surround one or more fibre yarns of the first material, which constitute the resistant insert core. The first material preferably is carbon fibre or PBO (acronym of the poly-p-phenylenbenzobisoxazole polymer), the second material preferably is aramid fibres, polyester fibres or glass fibres, even more preferably high module glass fibres (therefore glass type E, K, S, U according to the usual trade names).

Carbon fibres preferably are Toray fibres.

The inserts according to the present invention are twisted yarns and advantageously have a twist of the Lang's twist type, i.e. having two twists in the same direction since such construction has been proven to be particularly effective.

The number of yarns (“strand”) making up a resistant insert, as well as the number of base filaments or the titre or the entire construction of the insert may be varied while remaining within the ratios between the resistant insert diameters and thereby, according to the present invention.

The resistant inserts according to the present invention are preferably used in belts having a pitch ranging between 7 and 15 and the total diameter of the single resistant inserts is in the range between 0.9 and 3 mm. Preferably, in belts having a pitch ranging between 7 and 9, for example of 8 mm and or between 13 and 15, for example 14 mm.

The pitch is a parameter commonly used in the field of toothed belts and is the distance measured between the centre of two subsequent teeth.

If they are used in belts having a pitch of about 14 mm, it has been experimentally proven that optimal results are achieved when the nominal diameter of the single resistant inserts 3 is in the range between 1.5 and 3 mm, even more preferably between 2.0 and 2.6 mm.

If they are used in belts having a pitch of about 8 mm, it has been experimentally proven that optimal results are achieved when the nominal diameter of the single resistant inserts 3 is in the range between 0.9 and 2.1 mm; even more preferably between 0.9 and 1.5 mm.

4000 to 9000 filaments are preferably used for making the core in a bundle between 300 and 500 text (g/km).

Even more preferably, 6000 primary filaments are used in a bundle weighing 400 text (g/km).

Thus, in order to make the core starting from the carbon fibre bundle, this is first treated by a primary coating treatment. To this end, the fibre bundle is immersed in a bath containing latex and a crosslinker. The crosslinking mixture does not use resorcinol and therefore it is not RFL. The latex and crosslinker mixture preferably comprises a chlorosulfonated polyethylene (CSM) latex. The mixture penetrates into the fibre bundle and is then dried and made crosslinked.

The weight of the carbon fibre core impregnated with the primary coating typically is between 10 and 30% higher than before the treatment, even more preferably between 15 and 25% (measured in tex).

The primary core twist preferably is 0, i.e. the core does not preferably have a twist imparted on purpose.

The core is entirely surrounded by cover yarns.

The cover yarns are preferably made of a second material selected from the group consisting of glass, polyaramid or polyester. More preferably, they are made of glass. Even more preferably, they are made of glass E.

In order to make each cover yarn starting from the primary filament, one or more fibre bundles of the second material are preferably used, each bundle preferably comprises 100 to 500 filaments and has a weight from 10 to 50 tex per bundle.

The primary filaments preferably have a diameter ranging between 5 and 15 μm, even more preferably between 7 and 11 μm. The use of primary filaments with a diameter of 9 μm has been found to be particularly advantageous.

The fibres making up the primary filaments are pre-treated with an adhesive, for example a silane-based coupling agent.

The two primary filament bundles are preferably treated with a primary coating treatment. To this end, the two fibre bundles are immersed together in a bath containing a latex, resorcin and formaldehyde (RFL) mixture. In the immersion, the two glass bundles become a larger bundle that makes up the yarn (“strand”).

The RFL bath preferably includes a chlorosulfonated polyethylene (CSM) latex. The mixture penetrates into the fibre bundle and is then dried and crosslinked. After the crosslinking, a primary twist is applied to the yarns.

Preferably, the primary twist is in the range between 40 and 120 turns per metre, for example a primary twist of 80 turns per metre is particularly preferred.

The weight of the yarn treated with the primary RFL is typically higher by 20% than that of the original glass fibre bundle (measured in tex).

Thereafter, in order to make the final resistant insert, a plurality of cover yarns made as described above is wound about the core in a further twisting step.

10 to 25 fibre yarns are preferably wound about the core, even more preferably 12 to 18.

For example, 10 or 12 yarns may be wound about the core.

A particularly preferred embodiment of the present invention is to wind 12 glass fibre yarns with a twist of 70 turns per metre about a core consisting of a carbon fibre yarn obtained from two fibre bundles as described above.

A twist ranging between 0 and 120, more preferably between 60 and 100, is preferred for winding the yarns about the core. A twist of 80 turns per metre is particularly preferred.

The twisting direction is preferably in the same direction as the primary twist used for making the yarns that surround the core, i.e. a configuration known as “Lang's twist”.

After the twisting step of the yarns onto the resistant insert, a final adhesive coat or cover treatment is applied.

The coat is applied to the outer surface of the resistant insert. The coat preferably uses an adhesive including reactive chemical components dispersed in a chlorosulfonated polyethylene (CSM) solution.

The resistant insert weight after the coat application is preferably in the range between 2 and 10%, for example 5% higher than the resistant insert prior to the coat application.

Surprisingly, it has been found that when the toothed belt pitch is in the range between 7 and 15, belts are obtained by suitably selecting the number of yarns of the second material about the core of the first material and suitably selecting the diameters of the core and of the cover yarns, which have an especially long life and which solve the drawbacks described above.

In particular, the belts of the present invention have a pitch in the range between 8 and 15 mm. The resistant inserts each have a total diameter, indicated by φtot, in the range between 0.9 and 3 mm and consist of:
a core consisting of at least one yarn of fibres of a first material having a diameter φc
at least a number N of yarns in the range between 10 and 25 of fibres of a second material, the yarns totally surrounding the core.

It has been noted that when the ratios between the total diameters of the resistant insert and the diameter of the core are within the range 0.4<K<1

where:

K=φtot/2−(φtot−φc)/4,

the toothed belts have a particularly low breaking possibility and have excellent performance.

The twisting pitch is preferably in the range between φtot*1.035 and φtot*1.20.

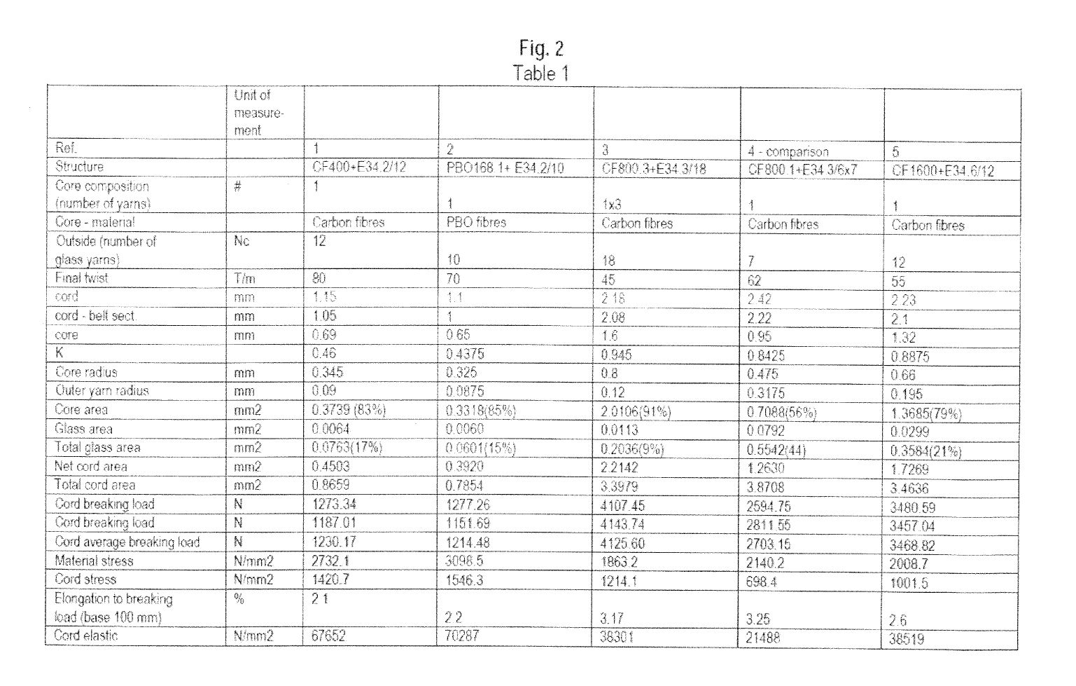

Resistant inserts wherein the area of the section of the core is more than 75% of the total area of the section of the resistant insert, even more preferably more than 80%, are particularly preferred. The percentage values of the area of the section of the core and of the total area of the section of the cover yarns are indicated in parentheses in Table 1 (FIG. 2).

When the resistant inserts 3 are selected according to the above ratios, a belt is obtained which is able to have a high driving power on pulleys.

The resistant inserts have an elastic module value higher than 30,000 N/mm² and preferably in the range between 30,000 and 90,000 N/mm². Even more preferably, between 50,000 and 80,000 N/mm². As can be seen in Table 1, the resistant inserts selected according to the above formula have resistant insert stress values significantly higher than the comparison resistant insert.

The belt according to the present invention may be made by common methods for manufacturing toothed belts.

An examination of the features of the toothed belt made according to the present invention clearly shows the advantages that it allows obtaining.

In particular, thanks to the high transmissible power, the belt according to the present invention may also be used for replacing the mechanical systems currently used. Moreover, thanks to the particular combination of the construction parameters it is possible to prevent the drawbacks related to the use of cords of aramid fibre or glass and steel and in particular the addition of further very expensive finishing steps, thus also simplifying the cutting process.

The toothed belt according to the present invention shall now be described also by examples without it being understood to be limited thereto.

### Example 1

### Process for Making Resistant Inserts According to the Present Invention

A core consisting of a first material is made starting from 6000 primary carbon filaments by the company Toray, each having fibres with a diameter of 7 μm. The bundle has a weight of 400 tex (g/km). The bundle is pre-treated with an adhesive. Thereafter, the bundle of primary filaments is treated with a primary cover by immersion in bath containing a crosslinking mixture containing latex and crosslinker. The crosslinking mixture does not use resorcinol and therefore it is not an RFL mixture. The crosslinking mixture includes the use of a chlorosulfonated polyethylene latex (CSM). The mixture penetrates into the fibre bundle and is then dried and crosslinked.

The weight of the primary filament bundle after the treatment is 16% higher than the weight before the treatment.

The primary core twist is 0, i.e. no twist is imparted.

Thereafter, the glass yarns E are made starting from two bundles of 200 primary filaments (34 tex per bundle) for making the cover yarns (“strand”) that will be wound about the core.

The primary filaments have a diameter of 9 μm. The fibres making up the primary filaments are pre-treated with a silane-based adhesive.

The two primary filament bundles are immersed in a bath containing a latex, resorcin and formaldehyde (RFL) mixture. In the immersion, the two glass bundles become a larger bundle that makes up the yarn (“strand”).

The RFL bath includes a chlorosulfonated polyethylene (CSM) latex. The mixture penetrates into the fibre bundle and is then dried and crosslinked. After the crosslinking, a primary twist of 80 turns per metre is applied.

The weight of the yarn treated with the primary RFL is typically higher by 20% than that of the original glass fibre bundle (measured in tex).

Thereafter, in order to make the final resistant insert, 12 yarns are wound about the core in a further twisting step with a twist of 80 turns per metre.

The twisting direction is “Lang's twist”, i.e. in the same direction as the primary twist used for making the yarns that surround the core.

After the twisting step of the yarns onto the resistant insert, a final adhesive coat or cover treatment is applied.

The coat is applied to the outer surface of the resistant insert. The coat uses an adhesive including reactive chemical components dispersed in a chlorosulfonated polyethylene (CSM) solution.

The resistant insert weight after the coat application is 5% higher than the resistant insert prior to the coat application.

Different resistant inserts were made with the same process described above, usable for making toothed belts according to the present invention or for comparison and the construction features thereof are shown in detail in table 1, presented as FIG. 2.

The table compares the construction features of some resistant inserts according to the invention, indicated with reference numerals 1, 2, 3 and 5 with a resistant insert 4 which has only 7 cover yarns about the core and therefore is for comparison and outside the parameters of the present invention.

The resistant inserts of table 2 only differ by the type of construction, i.e. number of yarns, diameter of the core or cover yarns, etc. shown in the same table.

From the examination of the diameter values indicated in the table it is clear that the resistant insert 4 has a much lower elastic module.

The resistant insert performance was then assessed with different tests shown in the following tables and figures.

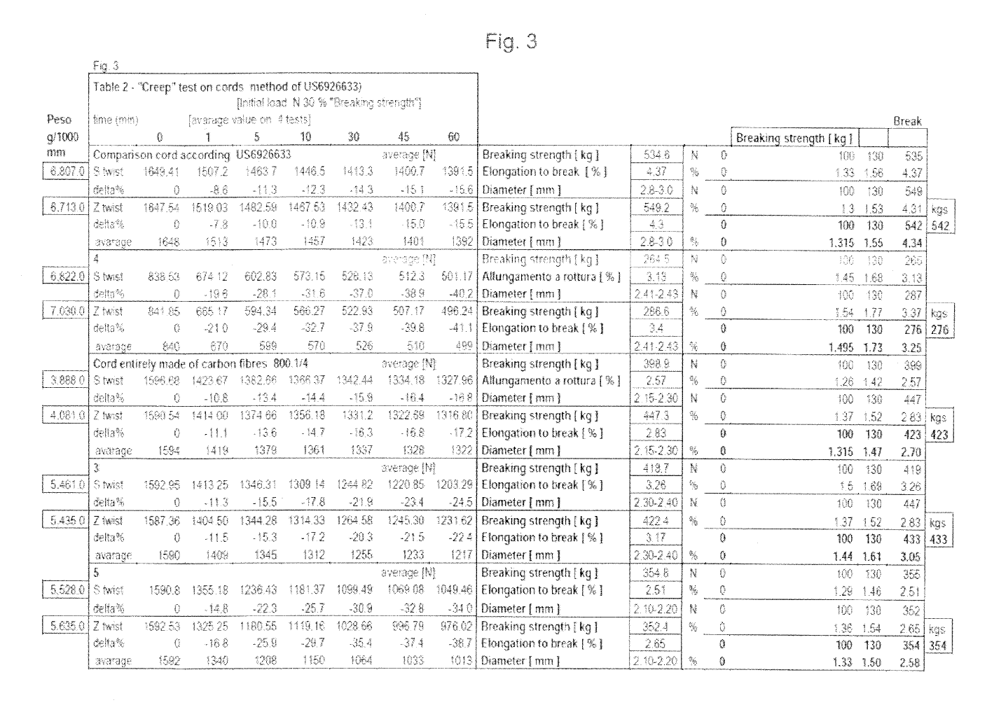

Table 2 in FIG. 3 shows the numerical data of a course decay test over time, elongation to break values, breaking strength and total diameters of various resistant inserts.

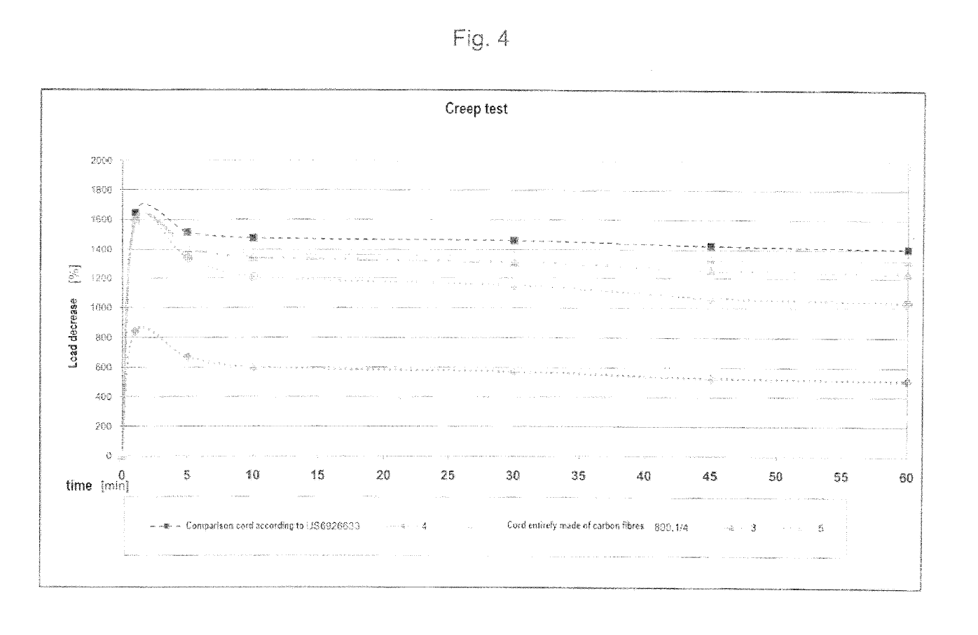

FIG. 4 further shows the numbers related to a voltage decay test or “creep” where some of the resistant inserts of table 1 of FIG. 2 have been subject to a creep test like that conducted according to the methods of U.S. Pat. No. 6,926,633.

The test was therefore carried out on a 5000 kg capacity dynamometer, with two pulleys whereon a belt with a pitch of 14 mm and having a width of 15 mm was mounted, whereto an axial load of 14000 N was applied. The wheelbase was then locked and the voltage decay data up to 60 minutes were recorded (in %).

It is immediately seen that the comparison insert 4 has much worse decay values than those according to the invention, indicated with reference numerals 3 and 5.

The test also compares the resistant inserts according to the present invention 3 and 5 and the resistant insert described in the above patent application entirely made of glass, the features whereof are shown hereinafter in table 3:

TABLE 3

| | |
|---|---|
| Number of base filaments | 180 ÷ 220 |
| Single filament diameter | 9 |
| First twist (twists/25 mm) | 2 |
| Final twist in opposite | 1 ± 0.2 |
| direction (T/25 mm) | |
| Primary and final twist | 2 |
| ratio | |
| Final insert diameter | 2.65 ± 0.15 |
| (mm) | |
| Breaking strength of | 525 ± 25 |
| the final cord (daN) | |
| Elongation to break (%) | 4.5 ± 0.5 |
| Elongation at 100 daN | max 1.8 |
| (%) | |
| Weight (gr/100 m) | 690 ± 10 |

From the joint observation of FIG. 4 and of table 2 of FIG. 3 it is noted that in order to have similar decay values it is necessary to use a resistant insert having a much larger diameter, with all the drawbacks resulting therefrom in terms of application.

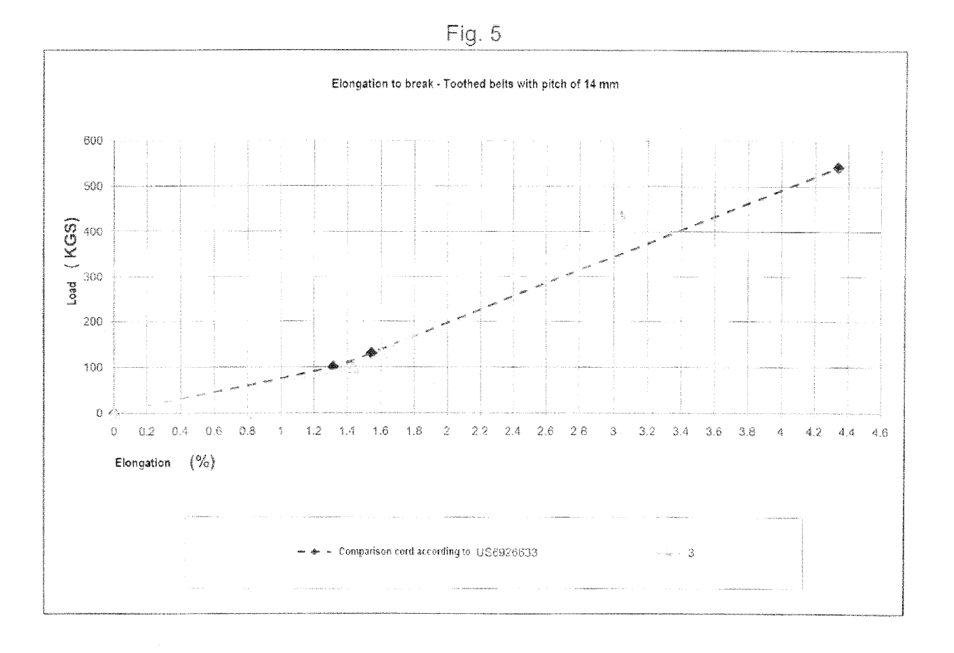

Moreover, from the elongation to break value shown in FIG. 5 it is noted that the comparison resistant insert has significantly lower performance than that obtained by the resistant insert 3 made according to the present invention.

In the table of FIG. 3 and in FIG. 4 it is also possible to compare a resistant insert entirely made of carbon fibre with the resistant inserts according to the present invention. In this case it is clear that with the same diameter it is possible to solve the above problems of adhesion to the body rubber and lack of flexibility of the carbon resistant insert while maintaining the same mechanical performance, such as course decay over time.

### Example 2

Table 4 shows the features of the weft and warp of a cover fabric 5 of a toothed belt 1 according to the present invention.

TABLE 4

| Weft features | |
|---|---|
| Weft construction | Double layer of weft yarns |
| | of texturised polyamide 6/6 |
| First weft layer | Medium tenacity polyamide |
| | 6/6 |
| Count (dtex) | 4 × 110 |
| Number of filaments | 4 × 34 |
| Second weft layer | High tenacity polyamide |
| Count (dtex) | 6 × 78 |
| Number of filaments | 6 × 34 |
| Weft yarns (no./25 mm) | 98 +/− 3 |
| (“Picks”) | |
| Breaking load (N/25 mm) | >1500 |
| Elongation to break (%) | 170 +/− 10 |
| Elongation at 100 N (%) | 90 +/− 10 |
| Warp features | |
| Warp construction | Single layer of high |
| | tenacity polyamide 6/6 |
| Count (dtex) | 940 |
| Number of filaments | 140 |
| Warp yarns (no./25 mm) | 105 +/− 3 |
| (“Ends”) | |
| Breaking load (N/25 mm) | >5000 |
| Elongation to break (%) | >25 |

Polyamide in the fabric: 60% high tenacity, 40% medium tenacity

### Example 3

Table 5 shows the compositions of the blend making up body 2 of a toothed belt A according to the invention and of a belt B made according to the teachings of U.S. Pat. No. 6,926,633. Such belt has a hardness of 93-94 ShoreA (54-55 Shore D) measured after vulcanisation while the comparison belt B has a hardness of 91-92 ShoreA.

TABLE 5

| | Amount | | Amount |
|---|---|---|---|
| Belt A | in Phr | Belt B | in Phr |
| HNBR | 100 | Chloroprene | 100 |
| Charge and | 60 | White charge and | 70 |
| carbon black | | carbon black | |
| Antioxidants | 2.5 | Antioxidants | 6 |
| Accelerators + | 9.5 | Accelerators + | 7 |
| activators | | Activators | |
| Process additives | 2 | Process additives | 9.5 |
| Binding agents | 1.5 | Binding agents | 8 |
| | | Reinforcing resins | 20 |
| Total | 175.5 | | 225.5 |

### Example 4

3 belts with a pitch of 8 mm were compared:

A belt B called 720 GLD8M 15 with a length of 720 mm and a composition of the body blend shown above and a composition of fabric and resistant inserts according to tables 2 and 3 of U.S. Pat. No. 6,926,633 and corresponds to belt A of such tables.

A belt A1 called 720PLT8M15 with a composition of the body blend shown in the above table 2, a composition of the fabric shown in table 1 and resistant inserts according to reference numeral 1 of table 1 (FIG. 2).

A belt A2 named 800PLT8M15 which is identical to belt A1 except for having a length of 800 mm instead of 720 mm.

The twisting pitch of the single resistant insert is 1.34 mm, for a total entire number of twists equal to 11, on the width of 15 mm.

The three types of belts were subject to dynamic tests.

Breaking tests were conducted on two powered test benches at room temperature with the following test configurations:

1. driving and driven pulley: Z=22, type RPP 8M, φp (pulley diameter)=56.024 mm

2. gear ratio: 1:1

3. driving rotation speed: 2750 rpm

4. braking torque: 24 Nm

5. equivalent dynamic tension [Td]: 857 N

6. Static belt mounting tension: 536 N/branch [+25% Td]

7. Test belt width: 15 mm

The test reference frequency indexes are the following in table 6:

TABLE 6

| | | Repeated |
|---|---|---|
| Belt | Cycle frequency | bending |
| 720M8-15 | 11.19 Hz(40300 cycles/hour, | 22.4 Hz |
| | 4.03 mil. cycles/100 hours) | |
| 800M8-15 | 10.08 Hz(36270 cycles/hour, | 20.16 Hz |
| | 3.63 mil. cycles/100 hours) | |

A total of 9 belts A2, 5 belts A1 and 8 belts B were made to break to have statistically significant samples to analyse with the Weibull analysis.

To this end, the analysis of the reliability of the same was carried out according to the Weibull method.

The following indexes were obtained for the Weibull formula:

TABLE 7

| Belt | Beta | B63% | hours |
|---|---|---|---|
| B | 4.09557 | 106.19 | 4.28 mil. cycles |
| A1 | 1.36899 | 358.05 | 14.43 mil. cycles |
| A2 | 1.39419 | 391.63 | 14.2 mil. cycles |

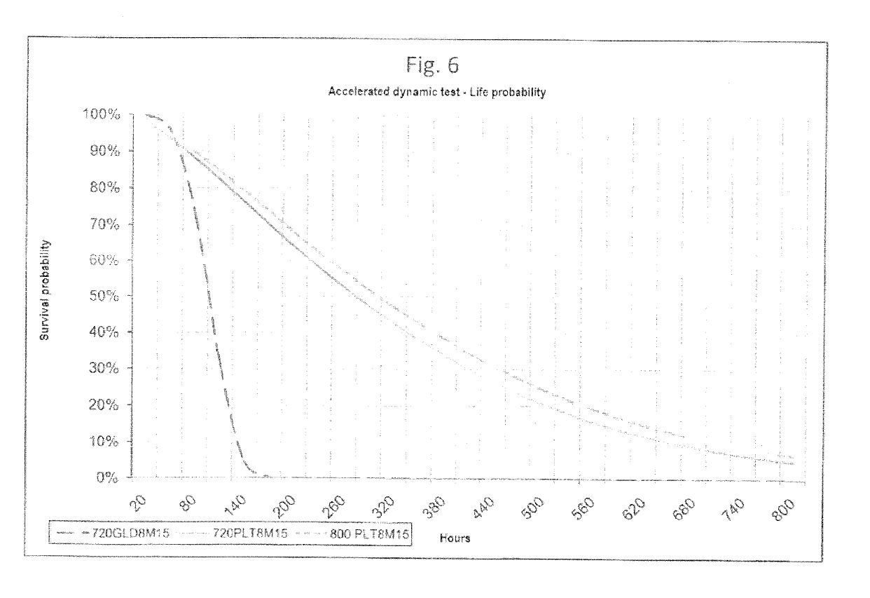

The results obtained for the survival probability are shown in FIG. 6.

From the graph of FIG. 6 it can be understood that:

The belts according to the present invention A1 and A2 have an average life 3 times higher than the comparison belts (index ratio B63% for 720M8); moreover, 80% of the population of belts according to the invention A1 and A2 exceeds 140 operating hours, while only 15% of the comparison belts is able to exceed such limit.

Finally, the belts according to the invention have a very high degree of repeatability of the results (low dispersion index), as shown by the data on the two different lengths.

1. A toothed belt comprising a body having teeth on at least one of the surfaces, a cover fabric adhering to the surface of the teeth and resistant inserts, wherein in that:
said toothed belt has a pitch in the range between 7 and 15 mm;
said resistant inserts each have a total diameter, indicated by φtot, in the range between 0.9 and 3 mm and consist of:
a core consisting of at least one yarn of fibres of a first material having a diameter φc
at least a number N of yarns of fibres of a second material, said number N being in the range between 10 and 25 and said N yarns totally surrounding said core;
the ratios between the total diameters of the resistant insert and the diameter of the core are the following:
0.4<K<1
where:
K=φtot/2−(φtot−φc)/4.

2. The toothed belt according to claim 1, wherein the area of the section of the core is more than 75% of the total area of the section of the resistant insert.

3. The toothed belt according to claim 1, having a twisting pitch in the range between 1.035 and 1.2 times the diameter φtot.

4. The toothed belt according to claim 1, having a pitch in the range between 7 and 9 mm or between 13 and 15 mm.

5. The toothed belt according to claim 1, wherein said first material is selected from the group consisting of carbon and PBO and said second material is selected from the group consisting of glass, aramid and polyester.

6. The toothed belt according to claim 1, wherein said first material is carbon and said second material is glass.

7. The toothed belt according to claim 1, wherein the elastic module of said resistant insert is higher than 30.000 N/mm2.

8. The toothed belt according to claim 1, wherein the elastic module of said resistant insert is in the range between 30.000 N/mm2 and 90.000 N/mm2.

9. The toothed belt according to claim 1, wherein said body comprises a main elastomer with a hardness after vulcanisation in the range between 90 and 97 ShoreA.

10. The toothed belt according to claim 9, wherein said body comprises a main elastomer without the addition of reinforcing fibres.

11. The toothed belt according to claim 1, comprising at least one polymer selected from the group consisting of acrylonitrile/butadiene, acrylonitrile, hydrogenated butadiene, acrylonitrile/carboxylated butadiene, acrylonitrile, hydrogenated and carboxylated butadiene and mixtures thereof.

12. The toothed belt according to claim 1, wherein said fabric is formed by a layer of fibres and has a total weight in the range between 700 g/m2 and 1100.

13. The toothed belt according to claim 11, wherein said fabric comprises texturised fibres.

14. The toothed belt according to claim 12, wherein said fabric comprises polyamide fibres.

15. The toothed belt according to claim 14, wherein said fabric comprises polyamide 6/6 fibres.
